(19) United States
(12) Patent Application Publication
(10) Pub. No.: US 2017/0008555 A1
(43) Pub. Date: Jan. 12, 2017

(54) POWER STEERING DEVICE AND METHOD FOR MANUFACTURING BALL SCREW FOR POWER STEERING DEVICE

(71) Applicant: HITACHI AUTOMOTIVE SYSTEMS, LTD., Hitachinaka-shi (JP)

(72) Inventors: Keisuke KITAMURA, Atsugi-shi, Kanagawa (JP); Hiroyuki SUGIYAMA, Atsugi-shi, Kanagawa (JP); Tatsuyoshi MARUYAMA, Atsugi-shi, Kanagawa (JP)

(73) Assignee: HITACHI AUTOMOTIVE SYSTEMS, LTD., Hitachinaka-shi, Ibaraki (JP)

(21) Appl. No.: 15/113,196

(22) PCT Filed: Jan. 14, 2015
(86) PCT No.: PCT/JP2015/050746

§ 371 Date: Jul. 21, 2016

(30) Foreign Application Priority Data
Feb. 27, 2014 (JP) 2014-036105

(51) Int. Cl. B62D 5/04; F16H 25/22

(52) U.S. Cl. CPC B62D 5/0448; B62D 5/0421; F16H 25/2214; F16H 2025/2096

(57) ABSTRACT

A power steering device provided to including: a steering shaft; a cylinder-like nut; a ball circulation groove including a steering shaft-side ball screw groove and a nut-side ball screw groove; balls; a first connecting passage; a second connecting passage; a connecting member; and an electric motor, wherein the first connecting passage has a first tapered part and the second connecting passage has a second tapered part, and the first connecting passage and the second connecting passage have an angle between the first tapered part and the second tapered part in the rotational direction of the nut, the angle being smaller than 180°.

### TECHNICAL FIELD

The present invention relates to a power steering device used as a rack assist type steering unit which assists travel of a rack bar by a rotational force of a motor transmitted through a belt or the like, and to a method for manufacturing a ball screw therefor.

### BACKGROUND OF THE INVENTION

As a ball screw used in conventional rack assist type power steering devices, a ball screw as discussed in the following Patent Publication 1 has been known, for example.

More specifically, this ball screw is configured such that a plurality of balls (as rolling elements) are provided between a pair of ball screw grooves so as to circulate therebetween through a tube, the ball screw grooves being formed opposing to each other at an inner and an outer peripheral part of a screw shaft and a nut. A portion where a ball releasing/collecting hole provided in the nut and the ball screw groove (i.e., a nut-side ball screw groove) are communicated with each other is processed to have a diameter-increasing tapered shape, thereby ensuring a smooth movement of the balls between the tube and the ball screw groove.

### REFERENCES ABOUT PRIOR ART

### Patent Documents

Patent Publication 1: Japanese Patent Application Publication No. 2001-141019

### SUMMARY OF THE INVENTION

### Problems to be Solved by the Invention

However, in the ball screw according to the above-mentioned conventional technique, there has been a problem that the diameter-increasing tapered portion cannot receive the load of the balls to lessen a load-receiving region for balls (hereinafter referred to as merely “a loading region”), though the movement of balls becomes smoothened by virtue of the diameter-increasing tapered portion.

The present invention has originated in view of the above technical problems, the object of which is to improve provide a power steering device and the like which can attain a smooth movement of balls while ensuring the balls a relatively wide loading region.

### Means for Solving the Problems

The present invention is particularly characterized in that: a first connecting passage formed opening at one end portion of a ball circulation groove has a first tapered part at its inward end region and at the side farther from a second connecting passage within a circumferential range formed along an opening defined at the inward end region, the inner diameter of the first tapered part being gradually reduced toward the opening defined at the inward end region, the second connecting passage being formed opening at the other end portion of the ball circulation groove; the second connecting passage has a second tapered part at its inward end region and at the side farther from the first connecting passage within a circumferential range formed along an opening defined at the inward end region, the inner diameter of the second tapered part being gradually reduced toward the opening defined at the inward end region; and the first connecting passage and the second connecting passage are provided to have an angle between the first tapered part and the second tapered part in the rotational direction of a nut, the angle being smaller than 180°.

### Effects of the Invention

it is possible to aim to smoothen the movement of the balls 43 between the ball circulation groove 42 and each of the first and second connecting passages 50, 60 while ensuring the balls 43 a relatively long loading region, and as a result, it is possible to ensure a good steering feeling of the power steering device.

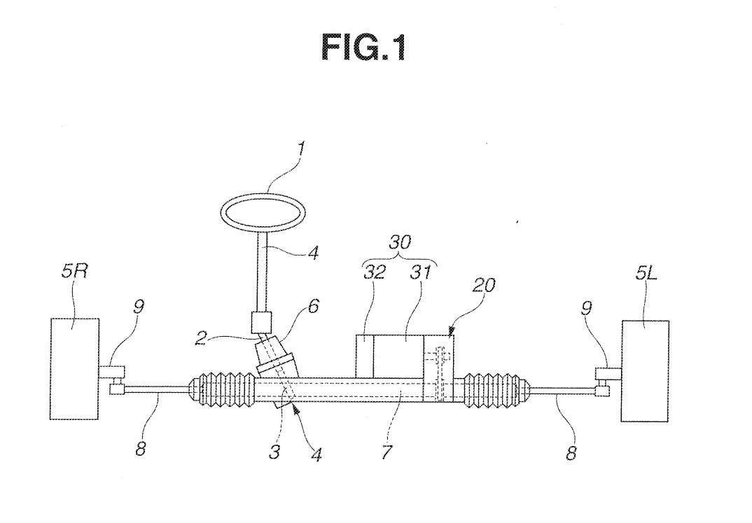

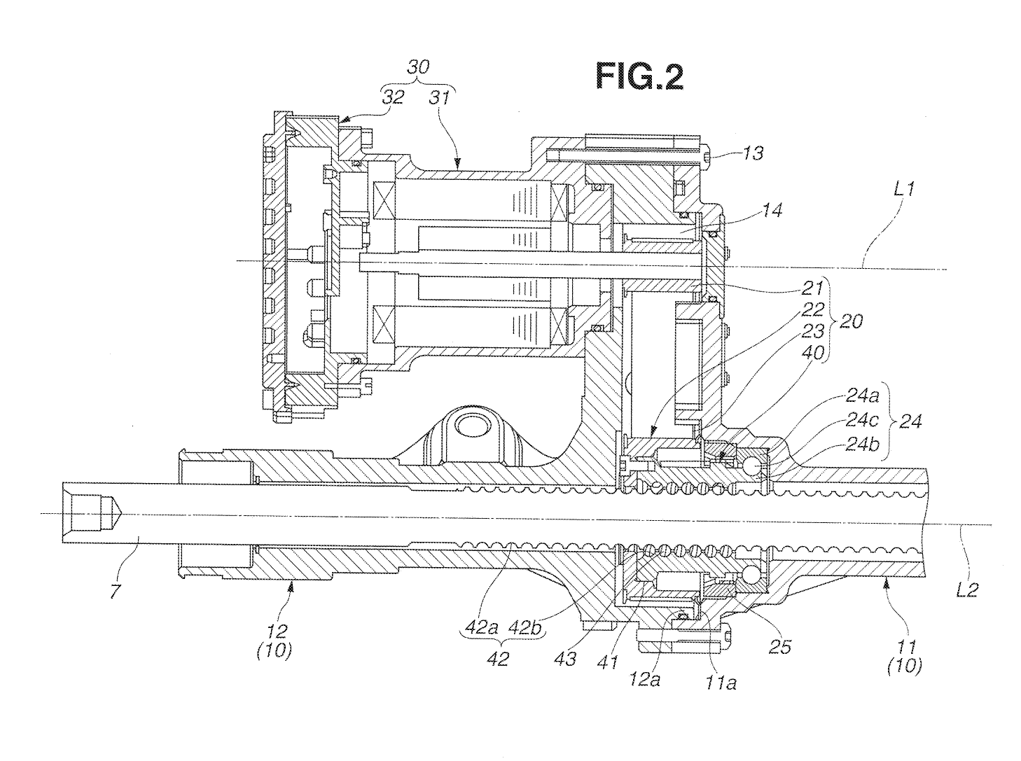

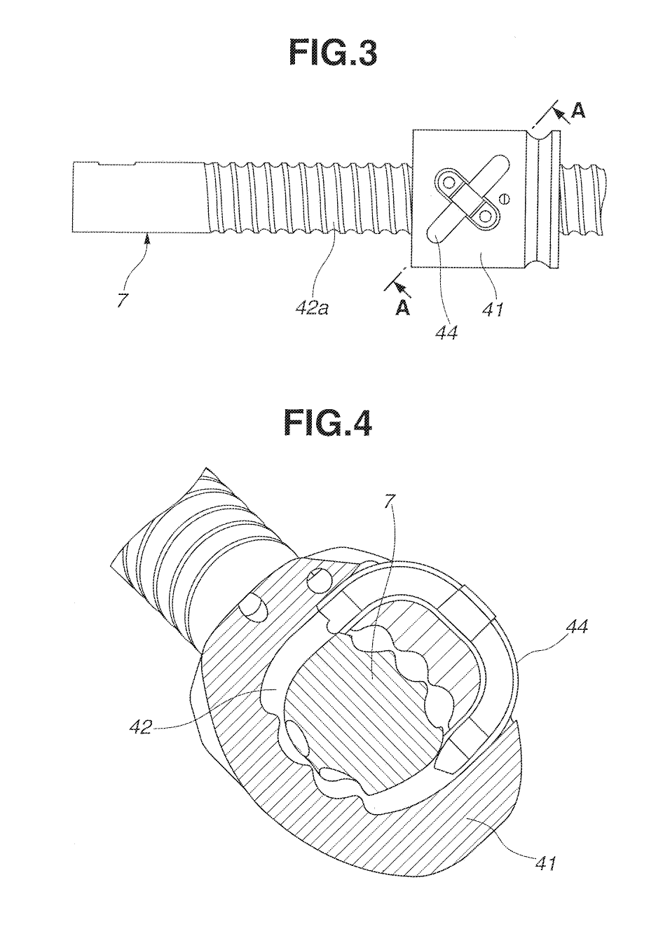

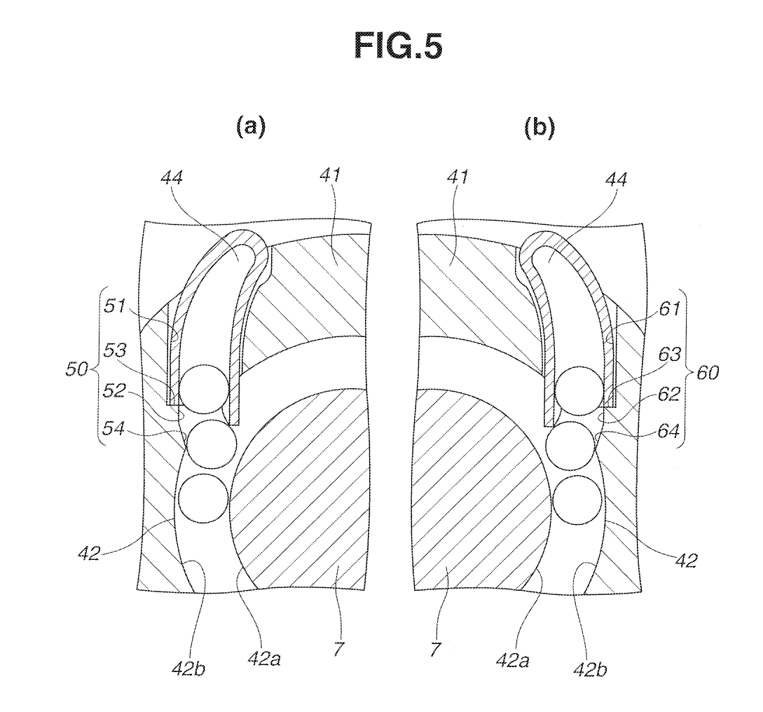

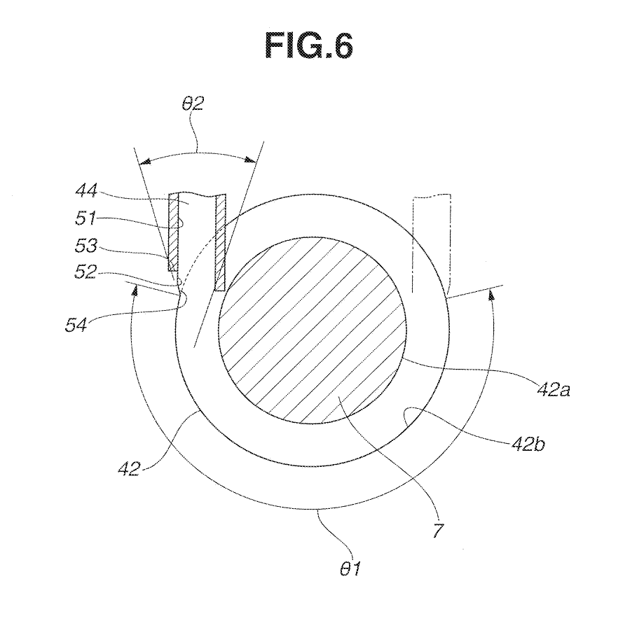

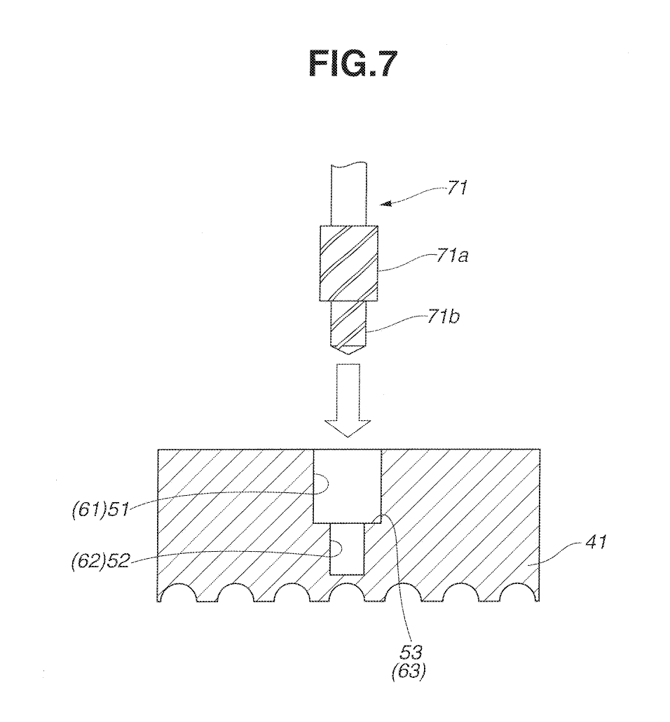

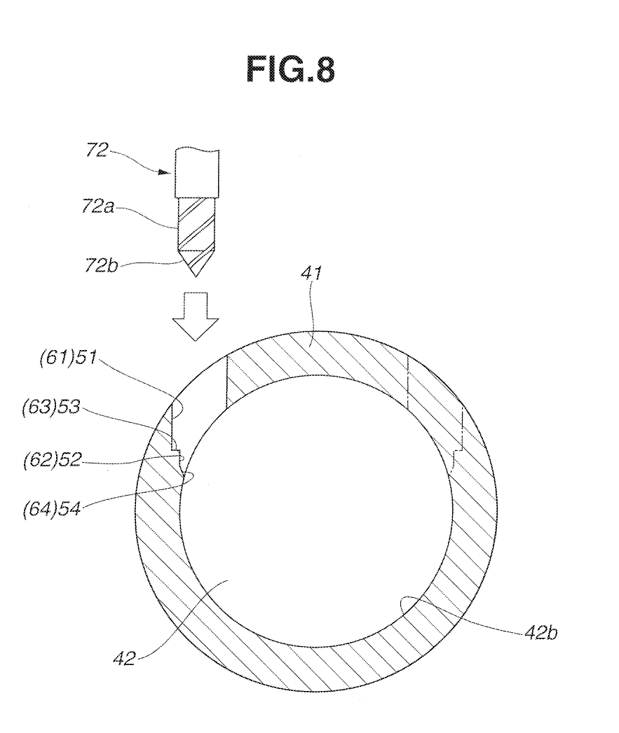

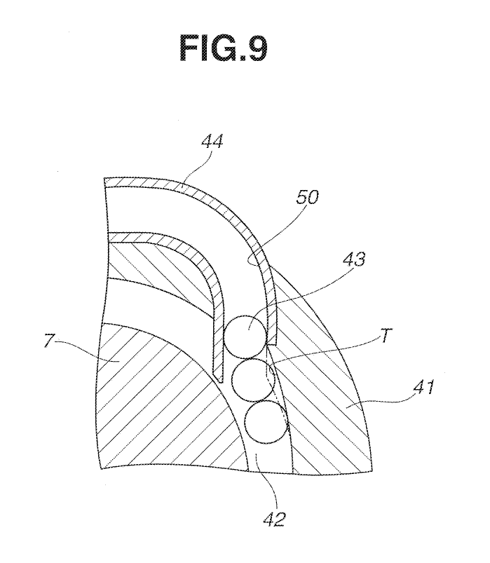

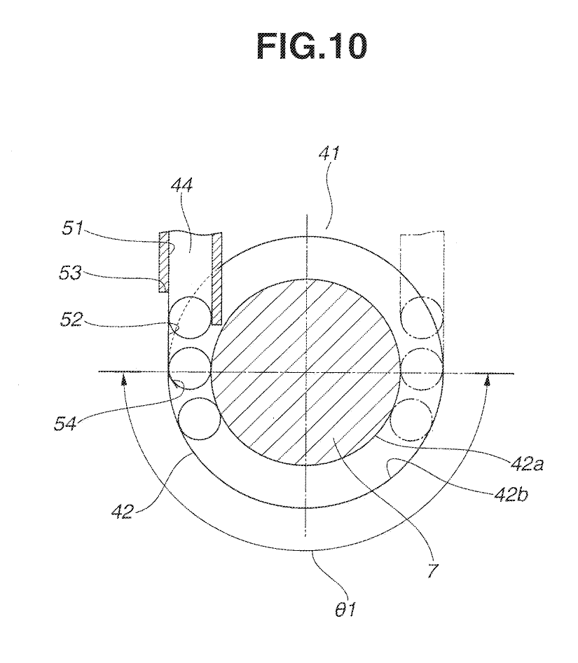

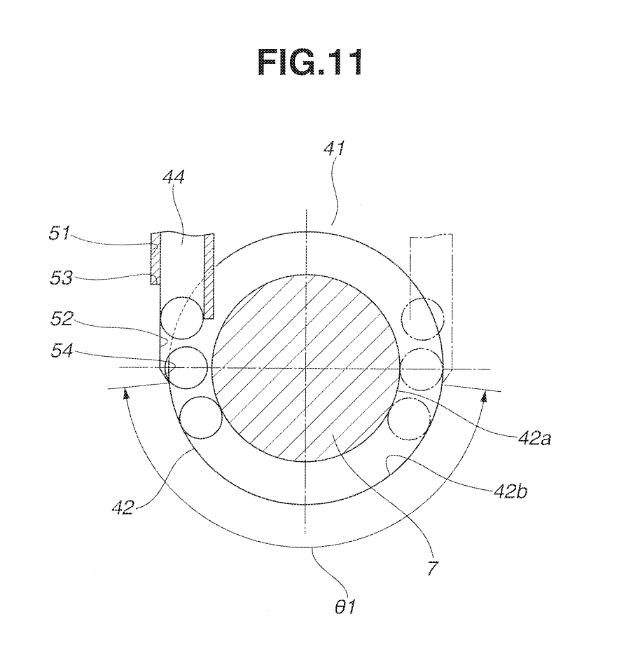

### BRIEF DESCRIPTION OF THE DRAWINGS

[FIG. 1] A schematic view of a power steering device according to the present invention.

[FIG. 2] An enlarged cross-sectional view of the vicinity of a motor unit as shown in FIG. 1.

[FIG. 3] A plan view of a ball screw as shown in FIG. 2.

[FIG. 4] A cross-sectional view taken along the line A-A of FIG. 3.

[FIG. 5] (a) A cross-sectional view of an essential part of one end portion of a ball circulation groove as shown in FIG. 4. (b) A cross-sectional view of an essential part of the other end portion of the ball circulation groove as shown in FIG. 4.

[FIG. 6] A schematic view of a ball nut, for explaining the structure of first and second connecting passages and first and second tapered parts as shown in FIG. 5.

[FIG. 7] A schematic view of a ball nut, showing a method of processing first and second large-diameter parts as shown in FIG. 5.

[FIG. 8] A schematic view of a ball nut, showing a method of processing first and second same-diameter parts and the first and second tapered parts as shown in FIG. 5.

[FIG. 9] A view corresponding to FIG. 5(a) but according to Comparative Example 1 cited as a conventional technique.

[FIG. 10] A view corresponding to FIG. 5(a) but according to Comparative Example 2.

[FIG. 11] A view corresponding to FIG. 5(a) but according to Comparative Example 3.

### MODE(S) FOR CARRYING OUT THE INVENTION

Referring now to the accompanying drawings, an embodiment of a power steering device and a method for manufacturing a ball screw for the power steering device according to the present invention will be discussed in detail. Incidentally, the undermentioned embodiment indicates the power steering device etc. as being applied to an automotive steering unit.

More specifically, as shown in FIG. 1, this power steering device is constructed mainly from: an input shaft 2 one end side of which is adapted to integrally rotatably communicate with a steering wheel 1; an output shaft 3 one end side of which is relatively rotatably connected to the other end side of the input shaft 2 through a not-illustrated torsion bar while the other end side of which is connected to steered road wheels 5L, 5R through a rack-and-pinion mechanism 4; a torque sensor 6 disposed on the outer peripheral side of the input shaft 2, for detecting a steering torque on the basis of a relative rotation displacement between the input shaft 2 and the output shaft 3; a motor unit 30 for transmitting a steering assist torque depending on a steering torque exerted by a driver to the undermentioned rack bar 7, the steering torque being based on detection results obtained by the torque sensor 6, a vehicle speed sensor (not shown) or the like; and a transmission mechanism 20 for reducing an output (a rotational force) of the motor unit 30 and transmitting it to the undermentioned rack bar 7 while converting the rotational force into a force that can move the rack bar 7 in an axial direction.

The rack-and-pinion mechanism 4 is arranged such that not-illustrated pinion teeth formed on an outer peripheral surface of one end region of the output shaft 3 are engaged with not-illustrated rack teeth formed over a certain axial range of the rack bar 7 disposed generally perpendicular to the one end region of the output shaft 3, thereby allowing the rack bar 7 to move in the axial direction according to the rotational direction of the output shaft 3. Additionally, the rack bar 7 is connected, respectively at its both end sections, to the steered road wheels 5R, 5L through tie rods 8, 8 and knuckle arms 9, 9. When the rack bar 7 is moved in the axial direction, one of the knuckle arms 9, 9 is pulled through one of the tie rods 8, 8 thereby changing the direction of the steered road wheels 5R, 5L.

As shown in FIGS. 1 and 2, the rack bar 7 is axially movably housed in a gear housing 10 where a first gear housing 11 provided for accommodating the rack-and-pinion mechanism 4 therein and a second gear housing 12 provided for accommodating the transmission mechanism 20 therein are integrally constructed. Incidentally, the first housing 11 and the second housing 12 joined by a plurality of bolts 13 (three bolts 13 in the present embodiment) for fastening the gear housing 10 to the motor unit 30, together with the motor unit 30, in a state where a projected portion 12a projectingly formed at a joined end part of the second housing 12 is fitted into a depressed portion 11a depressingly formed at a joined end part of the first gear housing 11.

As shown in FIG. 2, the above-mentioned transmission mechanism 20 is assembled mainly from: an input pulley 21 integrally rotatably attached to the outer periphery of the tip end part of an output shaft 31a of the undermentioned electric motor 31 so as to rotate about axis L1 of the output shaft 31a; an output pulley 22 relatively rotatably attached to the outer periphery of the rack bar 7 so as to rotate about axis L2 of the rack bar 7 when receiving the rotational force from the input pulley 21; a ball screw 40 mounted between the output pulley 22 and the rack bar 7, for converting the rotational force into axial movements of the rack bar 7 while reducing the speed of the rotations of the output pulley 22; and a belt 43 wound about both the input pulley 21 and the output pulley 22 for transmitting the rotations of the input pulley 21 to the output pulley 22 thereby achieving a coincidental rotation of both of the pulleys 21 and 22. The transmission mechanism 20 is disposed inside a transmission mechanism-accommodating region 14 defined between the joined end parts of the gear housings 11, 12.

The ball screw 40 is shaped like a cylinder surrounding the rack bar 7, and composed mainly of: a nut 41 relatively rotatable with respect to the rack bar 7; a ball circulation groove 42 including a rack bar-side ball screw groove 42a helically formed at the outer periphery of the rack bar 7 and a nut-side ball screw groove 42b helically formed at the inner periphery of the nut 41; a plurality of balls 43 provided rollably in the ball circulation groove 42; and a tube 44 serving as a tube-like connecting member which connects both ends of the ball circulation groove 42 to allow the balls 43 to circulate between the both ends of the ball circulation groove 42.

The nut 41 is rotatably supported at its axial one end section by the first gear housing 11 through a ball bearing 24, while the other end section is fixed such that its outer peripheral surface is fitted in the output pulley 22. For information, the ball bearing 24 consists of: an inner ring 24a provided integral with the nut 41; an outer ring 24b press-fitted against the inner peripheral surface of the first gear housing 11 and fastened with a locknut 25; and a plurality of balls 24c rollably provided between the inner and outer rings 24a, 24b.

Between the ball screw grooves 42a, 42b and between the inner and outer rings 24a, 24b, a given grease is applied in order to lessen friction associated with rolling motions of balls 43, 24c, respectively.

As shown in FIGS. 4 and 5, the above-mentioned nut 41 is connected at its axial one end section to one end part of the tube 44 so as to formed with a first connecting passage 50 for supplying or releasing the balls 43 to the ball circulation groove 42, the first connecting passage 50 piercing the nut 41 to open into the one end portion of the ball circulation groove 42 (i.e., the nut-side ball screw groove 42b). Likewise, the above-mentioned nut 41 is connected also at its axial other end section to the other end part of the tube 44 so as to formed with a second connecting passage 60 for ejecting or collecting the balls 43 from the ball circulation groove 42, the second connecting passage 60 piercing the nut 41 to open into the other end portion of the ball circulation groove 42 (i.e., the nut-side ball screw groove 42b), though a concrete illustration therefor is omitted.

The first and second connecting passages 50, 60 is so formed as to open at the outer peripheral surface of the nut 41, and respectively includes: a first large-diameter part 51 and a second large-diameter part 61 contributing to the connection of the tube 44; and a first same-diameter part 52 and a second same-diameter part 62 shaped like a step reducing the diameter inwardly from the first and second large-diameter parts 51, 61 to have a certain inner diameter while opening at the inner peripheral surface of the nut 41. There is provided a first step part 53 between the first large-diameter part 51 and the first same-diameter part 52, and there is provided a second step part 63 between the second large-diameter part 61 and the second same-diameter part 62. Furthermore, the first and second connecting passages 50, 60 are so adapted that an angle θ1 formed between the undermentioned first tapered part 54 and second tapered part 64 in the rotational direction of the nut 41 is not smaller than 90° and smaller than 180° (see FIG. 6).

The first same-diameter part 52 is formed including a first tapered part 54 the inner diameter of which is gradually reduced toward the side of the rack bar-side ball screw groove 42a, at its inner end region and on the side farther from the second same-diameter part 62 within a circumferential range formed along the edge opening at the side of the rack bar-side ball screw groove 42a. In the similar manner, the first same-diameter part 62 is formed including a second tapered part 64 the inner diameter of which is gradually reduced toward the side of the rack bar-side ball screw groove 42a, at its inner end region and on the side farther from the first same-diameter part 52 within a circumferential range formed along the edge opening at the side of the rack bar-side ball screw groove 42a. With this arrangement, a distance S formed between the inner surface of each of the first and second tapered parts 54, 64 and the outer surface of the rack bar-side ball screw groove 42a when viewed along the rotation axis of the nut 41 is gradually increased from the side of the ball circulation groove 42 toward the side of the tube 44. Incidentally, a tapered angle θ2 of each of the first and second tapered parts 54, 64 is set to less than 120° (see FIG. 6).

By the way, either of the first and second connecting passages 50, 60 including the first and second tapered parts 54, 64 is processed by machining in use of a tapering drill 72 having at its tip end section a tapering section 72b formed tapered along the above-mentioned tapered parts 54, 64, the drill 72 being inserted from the outer peripheral side of the nut 41 (see FIGS. 7 and 8). Incidentally, a concrete method for processing the both connecting passages 50, 60 will be discussed later as a method for producing the ball screw 40.

The tube 44 has a tube-like shape one end part of which is so fittingly inserted into the first large-diameter part 51 as to be in contact with the first step part 53 and the other end part of which is so fittingly inserted into the second large-diameter part 61 as to be in contact with the second step part 63. Since the tube 44 is adapted to be brought into contact with the first and second step parts 53, 63, the positioning in the inserting direction at the time of attaching the tube 44 can easily be accomplished.

Additionally, the tube 44 is also formed having first and second guide parts 44a, 44b (for guiding the movement of the balls 43 between the first and second same-diameter parts 52,62 and ball circulation groove 42) at the side opposing to the first and second tapered parts 54, 64 of one end part and the other end parts, respectively. The first and second guide parts 44a, 44b are formed extending from openings defined by the inward end regions of the first and second same-diameter parts 52, 62 to the vicinity of the rack bar-side ball screw groove 42a. The first and second guide parts 44a, 44b are shaped into a tongue continuing to the ball circulation groove 42, and formed to have a curved surface with which the movement of the balls 43 from the first same-diameter part 52 to the ball circulation groove 42 and that from the ball circulation groove 42 to the second same-diameter part 62 gets smoothened.

As shown in FIG. 2, the motor unit 30 is provided such that the electric motor 31 (supported and fixed by the second gear housing 12 at the axial one end side on which the output shaft 31a is projectingly attached, and able to transmit a steering assist force to the rack bar 7 through the transmission mechanism 20 when the input pulley 21 is rotationally driven) and an electronic controller 32 (attached to the other end side of the electric motor 31, for controlling the driving of the electric motor 31 depending on certain parameters such as the steering torque and the vehicle speed) are integrally constructed.

Referring now to FIGS. 4, 7 and 8, a method for manufacturing the ball screw 40 will be discussed.

First of all, the nut 41 is pierced with a passage-forming drill 71 from the outer peripheral side of one end section thereby forming the first large-diameter part 51 and a prepared hole of the first same-diameter part 52 concurrently, as shown in FIG. 7. More specifically, the passage-forming drill 71 is shifted in its axial direction from the outer peripheral side of the nut 41 along a single direction, thereby forming the first large-diameter part 51 by a large-diameter bit 71a located on the base end side of the passage-forming drill 71, while forming a prepared hole for the first same-diameter part 52 by a small-diameter bit 71b located on the tip end side of the passage-forming drill 71. Also at the other end section of nut 41, the passage-forming drill 71 is similarly shifted in its axial direction along a single direction, thereby forming the second large-diameter part 61 and a prepared hole of the second same-diameter part 62 concurrently.

Subsequently, the first and second large-diameter parts 51, 61 are processed, followed by shifting the tapering drill 72 in the axial direction from the side of the first large-diameter part 51 of the first connecting passage 50 along the center of the first large-diameter part 51 as shown in FIG. 8 so as to form the first tapered part 54 by the tapered section 72b that the drill 72 has at its tip end section while forming the first and second same-diameter parts 52, 62 by a linear section 72a of the drill 72, thereby achieving the opening of the first connecting passage 50. Also concerning the side of second connecting passage 60, the above-mentioned tapering drill 72 is similarly shifted in the axial direction from the side of the second large-diameter part 61 along the center of the second large-diameter part 61 to form the second same-diameter part 62 and the second tapered part 64, thereby achieving the opening of the second connecting passage 60.

Thereafter, as shown in FIG. 4, the tube 44 is fixed in such a manner as to be fittingly inserted into the thus machined first and second large-diameter parts 51, 61 of the first and second connecting passages 50, 60 of the nut 41 until one end part and the other end part of the tube 44 are brought into contact with the first and second step parts 53, 63, respectively, thereby accomplishing assembly of the ball screw 40.

Hereinafter the significant advantages of the power steering device according to the present embodiment will be discussed by referring to FIGS. 5, 9 and 10 while comparing with conventional techniques or other Comparative Examples.

In the formation of the first and second connecting passages 50, 60, there has been a case where boundary portions between the ball circulation groove 42 and each of the connecting passages 50, 60 smoothly communicate with each other through a diameter-increasing tapered portion T (like Comparative Example 1 shown in FIG. 9 as a conventional technique), and a case where the first and second connecting passages 50, 60 are formed closer to the outer peripheral side of the ball circulation groove 42 (like Comparative Example 2 as shown in FIG. 10); however, in these cases there has been a problem that a loading region for the balls 43 is lessened as indicated in each of the drawings by an arrow.

On the contrary, the present embodiment is arranged to have the first and second tapered parts 54, 64 the inner diameter of which is gradually reduced toward the opening of the nut-side ball screw groove 42b, at the inward end regions of the first and second connecting passages 50, 60, respectively, as shown in FIG. 5. With this arrangement, it is possible to aim to smoothen the movement of the balls 43 between the ball circulation groove 42 and each of the first and second connecting passages 50, 60 while ensuring the balls 43 a relatively long loading region, and as a result, it is possible to ensure a good steering feeling of the power steering device.

Moreover, the first and second tapered parts 54, 64 have such a structure that a distance formed between the inner surface of each of the first and second tapered parts 54, 64 and the outer surface of the rack bar-side ball screw groove 42a when viewed along the rotation axis of the nut 41 is gradually increased from the side of the ball circulation groove 42 toward the side of the tube 44. With this, the balls 43 can smoothly change its travel direction thereby contributing to the attainment of a better steering feeling.

Furthermore, in the formation of the first and second tapered parts 54, 64, the angle θ1 formed between the first tapered part 54 and the second tapered part 64 in the rotational direction of the nut 41 is arranged to be smaller than 180°. With such an arrangement, it is possible to ensure the balls 43 a longer loading region as compared with a case of FIG. 11 where the angle θ1 between the first and second tapered parts 54, 64 is not smaller than 180°.

Additionally, the angle θ1 formed between the first and second tapered parts 54, 64 is arranged to be not smaller than 90°. With this, a relative angle formed between the ball circulation groove 42 and each of the first and second connecting passages 50, 60 is restrained, so that it can be expected that the movement of the balls 43 between the ball circulation groove 42 and each of the connecting passages 50, 60 gets more smoothened.

In addition, a tapered angle of each of the tapered parts 54, 64 is set to less than 120°. With this, there is brought about an advantage that the movement of the balls 43 between the ball circulation groove 42 and each of the connecting passages 50, 60 gets more smoothened.

Furthermore, in the conventional technique as shown in FIG. 9 where the ball circulation groove 42 and each of the connecting passages 50, 60 are communicated with each other through the diameter-increasing tapered portion T, it is necessary to form the diameter-increasing tapered portion T separately from the connecting passages 50, 60, which results in a problem of bringing about productivity reduction in production of balls 43.

On the contrary, in the ball screw 40 according to an embodiment of the present invention, the first and second tapered parts 54, 64 are formed such that its inner diameter is gradually reduced toward the nut-side ball screw groove 42b. With this, it is possible to form the first and second tapered parts 54, 64 only by processing the first and second large-diameter parts 51, 61 and the first and second same-diameter parts 52, 62 with the passage-forming drill 71 and then shifting the tapering drill 72 in the axial direction along the same axis as that of the passage-forming drill 71, without particularly changing the posture of the workpiece (the nut 41). Therefore, there is no fear that the ball screw 40 is subjected to productivity reduction.

In other words, according to an embodiment of the present invention, the first and second connecting passages 50, 60 including the first and second tapered parts 54, 64 can be formed by a single drilling as a whole, which means that the first and second connecting passages 50, 60 are formed with ease and high accuracy.

In particular, the first and second same-diameter parts 52, 62 and the first and second tapered parts 54, 64 can concurrently be formed by the above-mentioned single tapering drill 72, respectively, which advantageously ensures the ball screw 40 a good processing workability while suppressing its productivity reduction.

Also concerning the first and second step parts 53, 63, it is possible to process them by a tip end surface of the large-diameter bit 71a of the passage-forming drill 71 concurrently when processing the first and second large-diameter parts 51, 61 by the passage-forming drill 71; therefore, the ability for processing the ball screw 40 may be more enhanced.

Additionally, since the first and second connecting passages 50, 60 are respectively provided with the first and second same-diameter parts 52, 62 the inner diameter of which is fixed and substantially equal to that of the tube 44, it is possible to ensure smooth movements of the balls 43 within the first and second connecting passages 50, 60.

Moreover, the part into which the tube 44 is fittingly inserted is provided as the first and second large-diameter parts 51, 61 having a diameter increased in an amount of the thickness of the tube 44 while the first and second step parts 53, 63 are disposed therebetween. Accordingly, at the time of attaching the tube 44 it is required only to fittingly insert the tube 44 until one end part and the other end part thereof are brought into contact with the first and second step parts 53, 63, which brings about an advantage that the positioning of the tube 44 can easily be accomplished.

Additionally, the tube 44 is also formed having the first guide part 44a and the second guide part 44b at the side opposing to the first and second tapered parts 54, 64 of one end part and the other end parts, the first and second guide parts 44a, 44b being formed extending from openings defined by the inward end regions of the first and second connecting passages 50, 60 to the vicinity of the rack bar-side ball screw groove 42a, respectively. This arrangement contributes to the attainment of more smoothened movements of the balls 43 between the ball circulation groove 42 and the first and second connecting passages 50, 60.

The present invention is not limited to the above-mentioned embodiments. For example, the location of the opening of the first and second connecting passages 50, 60 in the circumferential direction of the nut-side ball screw groove 42b may freely be modified according to the ball screw 40 to be applied, the specifications of the power steering device and the like, within a scope of the present invention.

Hereinafter, technical ideas grasped from the above embodiment will be discussed in (a) to (r), together with advantages obtained thereby as necessary.

(a) A power steering device characterized by comprising:

a steering shaft adapted to move in the axial direction together with rotation of a steering wheel thereby steering a steered road wheel;

a nut shaped into a cylinder surrounding the steering shaft to be relatively rotatable with respect to steering shaft;

a ball circulation groove including a steering shaft-side ball screw groove helically formed at the outer periphery of the steering shaft, and a nut-side ball screw groove helically formed at the inner periphery of the nut;

a plurality of balls provided rollably in the ball circulation groove;

a first connecting passage one end side of which is formed to open at the outer peripheral surface of the nut and the other end side of which is formed to open at the inner peripheral surface of the nut and at one end portion of the ball circulation groove;

a second connecting passage one end side of which is formed to open at the outer peripheral surface of the nut and the other end side of which is formed to open at the inner peripheral surface of the nut and at the other end portion of the ball circulation groove;

a connecting member which connects the first connecting passage with the second connecting passage to allow the balls to circulate between the both connecting passages; and

an electric motor able to rotationally drive the nut thereby transmitting a steering force to the steering shaft,

wherein the first connecting passage has a first tapered part at the side farther from the second connecting passage within a circumferential range formed along the other end side opening, the inner diameter of the first tapered part being gradually reduced toward the other end side opening,

the second connecting passage has a second tapered part at the side farther from the first connecting passage within a circumferential range formed along the other end side opening, the inner diameter of the second tapered part being gradually reduced toward the other end side opening, and

the first connecting passage and the second connecting passage are provided to have an angle between the first tapered part and the second tapered part in the rotational direction of the nut, the angle being smaller than 180°.

(b) A power steering device as discussed in the technical idea (a), characterized in that the first connecting passage and the second connecting passage are formed by drilling.

(c) A power steering device as discussed in the technical idea (b), characterized in that the first connecting passage and the second connecting passage are formed by a drill which moves from the outer peripheral side of the nut toward the inner peripheral side of the nut,

the drill has at its tip end section a tapering section formed tapered along the shape of the first tapered part and the second tapered part, and

the first tapered part and the second tapered part are formed by the tapering section.

(d) A power steering device as discussed in the technical idea (a), characterized in that the connecting member has a tube-like shape one end side of which is fittingly inserted into the first connecting passage and the other end side of which is fittingly inserted into the second connecting passage,

the first connecting passage has a first same-diameter part between one end side of the connecting member and the first tapered part, the first same-diameter part serving as a part in which the inner diameter of the first connecting passage is not changed, and

the second connecting passage has a second same-diameter part between the other end side of the connecting member and the second tapered part, the second same-diameter part serving as a part in which the inner diameter of the second connecting passage is not changed.

(e) A power steering device as discussed in the technical idea (d), characterized in that the first connecting passage includes a first large-diameter part formed having a diameter larger than that of the first same-diameter part, on one end side of the first connecting passage with respect to the first same-diameter part,

the second connecting passage includes a second large-diameter part formed having a diameter larger than that of the second same-diameter part, on one end side of the second connecting passage with respect to the second same-diameter part, and

the connecting member is attached to be in contact with a first step part at one end side while being in contact with a second step part at the other end side, the first step part being disposed between the first same-diameter part and the first large-diameter part, the second step part being disposed between the second same-diameter part and the second large-diameter part.

(f) A power steering device as discussed in the technical idea (a), characterized in that the first tapered part is formed to have a distance between the first tapered part and the outer peripheral surface of the steering shaft-side ball screw groove in the radial direction of the rotation axis of the nut which distance is gradually increased from the side of the ball circulation groove toward the side of the connecting member, and

the second tapered part is formed to have a distance between the second tapered part and the outer peripheral surface of the steering shaft-side ball screw groove in the radial direction of the rotation axis of the nut which distance is gradually increased from the side of the ball circulation groove toward the side of the connecting member.

(g) A power steering device as discussed in the technical idea (f), characterized in that

the connecting member includes, at one end side, a first guide part opposing to the first tapered part and extending from an opening defined at the other end side of the first connecting passage to the vicinity of the steering shaft-side ball screw groove, and

the connecting member includes, at the other end side, a second guide part opposing to the second tapered part and extending from an opening defined at the other end side of the second connecting passage to the vicinity of the steering shaft-side ball screw groove.

This arrangement allows the balls to be guided from the connecting passage to the ball circulation groove, thereby contributing to the attainment of more smoothened movements of the balls.

(h) A power steering device as discussed in the technical idea (a), characterized in that

the first tapered part and the second tapered part have their respective tapered angles of less than 120°.

This arrangement contributes to the attainment of more smoothened movements of the balls between the connecting passage and the ball circulation groove.

(i) A power steering device as discussed in the technical idea (a), characterized in that

the first connecting passage and the second connecting passage are provided to have an angle between the first tapered part and the second tapered part in the rotational direction of the nut, the angle being 90° or more.

With this arrangement, a relative angle formed between the ball circulation groove and each of the first and second connecting passages is restrained, so that it can be expected that the movement of the balls between the connecting passage and the ball circulation groove gets more smoothened.

(j) A method for manufacturing a ball screw for use in a power steering device comprising:

a steering shaft adapted to move in the axial direction together with rotation of a steering wheel thereby steering a steered road wheel;

a nut shaped into a cylinder surrounding the steering shaft to be relatively rotatable with respect to steering shaft;

a ball circulation groove including a steering shaft-side ball screw groove helically formed at the outer periphery of the steering shaft, and a nut-side ball screw groove helically formed at the inner periphery of the nut;

a plurality of balls provided rollably in the ball circulation groove;

a first connecting passage one end side of which is formed to open at the outer peripheral surface of the nut and the other end side of which is formed to open at the inner peripheral surface of the nut and at one end portion of the ball circulation groove;

a second connecting passage one end side of which is formed to open at the outer peripheral surface of the nut and the other end side of which is formed to open at the inner peripheral surface of the nut and at the other end portion of the ball circulation groove;

a connecting member which connects the first connecting passage with the second connecting passage to allow the balls to circulate between the both connecting passages; and

an electric motor able to rotationally drive the nut thereby transmitting a steering force to the steering shaft,

the method being characterized by comprising:

a first step of processing the first connecting passage by a tapered drill the diameter of which is reduced toward its tip end section thereby forming a first tapered part at the other end side of the first connecting passage, the inner diameter of the first tapered part being gradually reduced toward an opening defined at the other end side of the first connecting passage; and

a second step of processing the second connecting passage by a tapered drill the diameter of which is reduced toward its tip end section thereby forming a second tapered part at the other end side of the second connecting passage, the inner diameter of the second tapered part being gradually reduced toward an opening defined at the other end side of the second connecting passage,

wherein the first connecting passage and the second connecting passage are provided to have an angle between the first tapered part and the second tapered part in the rotational direction of the nut, the angle being smaller than 180°.

(k) A method for manufacturing a ball screw for use in a power steering device, as discussed in the technical idea (j), characterized in that

the connecting member has a tube-like shape one end side of which is fittingly inserted into the first connecting passage and the other end side of which is fittingly inserted into the second connecting passage,

the first connecting passage has a first same-diameter part between one end side of the connecting member and the first tapered part, the first same-diameter part serving as a part in which the inner diameter of the first connecting passage is not changed, and

the second connecting passage has a second same-diameter part between the other end side of the connecting member and the second tapered part, the second same-diameter part serving as a part in which the inner diameter of the second connecting passage is not changed.

With this arrangement, a more smoothened movement of the balls between the connecting member and each tapered part is expected.

(l) A method for manufacturing a ball screw for use in a power steering device, as discussed in the technical idea (k), characterized in that each of a pair of the first connecting passage and the first same-diameter part and a pair of the second connecting passage and the second same-diameter part is formed by a single drilling.

With this arrangement, the ball screw is improved in productivity.

(m) A method for manufacturing a ball screw for use in a power steering device, as discussed in the technical idea (k), characterized in that each of the pair of the first connecting passage and the first same-diameter part and the pair of the second connecting passage and the second same-diameter part is formed by moving a drill in the same rotation axis.

With this arrangement, it becomes possible to process each tapered part and same-diameter part concurrently by one chucking, so that the ball screw is expected to be improved in productivity,

(n) A method for manufacturing a ball screw for use in a power steering device, as discussed in the technical idea (m), characterized in that

the first connecting passage includes a first large-diameter part formed having a diameter larger than that of the first same-diameter part, on one end side of the first connecting passage with respect to the first same-diameter part,

the second connecting passage includes a second large-diameter part formed having a diameter larger than that of the second same-diameter part, on one end side of the second connecting passage with respect to the second same-diameter part,

each of the first large-diameter part and the second large-diameter part is formed by drilling, and

the connecting member is attached to be in contact with a first step part at one end side while being in contact with a second step part at the other end side, the first step part being disposed between the first same-diameter part and the first large-diameter part, the second step part being disposed between the second same-diameter part and the second large-diameter part.

With this arrangement, the step parts in the connecting passages may be expected to be improved in workability.

(o) A method for manufacturing a ball screw for use in a power steering device, as discussed in the technical idea (j), characterized in that

the first tapered part is formed to have a distance between the first tapered part and the outer peripheral surface of the steering shaft-side ball screw groove in the radial direction of the rotation axis of the nut which distance is gradually increased from the side of the ball circulation groove toward the side of the connecting member, and

the second tapered part is formed to have a distance between the second tapered part and the outer peripheral surface of the steering shaft-side ball screw groove in the radial direction of the rotation axis of the nut which distance is gradually increased from the side of the ball circulation groove toward the side of the connecting member.

This arrangement contributes to the attainment of more smoothened movements of the balls between the connecting passage and the ball circulation groove.

(p) A method for manufacturing a ball screw for use in a power steering device, as discussed in the technical idea (o), characterized in that

the connecting member includes, at one end side, a first guide part opposing to the first tapered part and extending from an opening defined at the other end side of the first connecting passage to the vicinity of the steering shaft-side ball screw groove, and

the connecting member includes, at the other end side, a second guide part opposing to the second tapered part and extending from an opening defined at the other end side of the second connecting passage to the vicinity of the steering shaft-side ball screw groove.

This arrangement allows the balls to be guided from the connecting passage to the ball circulation groove, thereby contributing to the attainment of more smoothened movements of the balls,

(q) A method for manufacturing a ball screw for use in a power steering device, as discussed in the technical idea (j), characterized in that

the first tapered part and the second tapered part have their respective tapered angles of less than 120°.

This arrangement contributes to the attainment of more smoothened movements of the balls between the connecting passage and the ball circulation groove.

(r) A method for manufacturing a ball screw for use in a power steering device, as discussed in the technical idea (j), characterized in that

the first connecting passage and the second connecting passage are provided to have an angle between the first tapered part and the second tapered part in the rotational direction of the nut, the angle being 90° or more.

With this arrangement, a relative angle formed between the ball circulation groove and each of the first and second connecting passages is restrained, so that it can be expected that the movement of the balls between the connecting passage and the ball circulation groove gets more smoothened.

### EXPLANATION OF REFERENCE NUMERALS

7 Rack bar (Steering shaft)

31 Electric motor

40 Ball screw

41 Nut

42 Ball circulation groove

42a Rack bar-side ball screw groove

42b Nut-side ball screw groove

43 Ball

44 Tube

50 First connecting passage

60 Second connecting passage

54 First tapered part

64 Second tapered part

1. A power steering device characterized by comprising:
a steering shaft adapted to move in the axial direction together with rotation of a steering wheel thereby steering a steered road wheel;
a nut shaped into a cylinder surrounding the steering shaft to be relatively rotatable with respect to steering shaft;
a ball circulation groove including a steering shaft-side ball screw groove helically formed at the outer periphery of the steering shaft, and a nut-side ball screw groove helically formed at the inner periphery of the nut;
a plurality of balls provided rollably in the ball circulation groove;
a first connecting passage one end side of which is formed to open at the outer peripheral surface of the nut and the other end side of which is formed to open at the inner peripheral surface of the nut and at one end portion of the ball circulation groove;
a second connecting passage one end side of which is formed to open at the outer peripheral surface of the nut and the other end side of which is formed to open at the inner peripheral surface of the nut and at the other end portion of the ball circulation groove;
a connecting member which connects the first connecting passage with the second connecting passage to allow the balls to circulate between the both connecting passages; and
an electric motor able to rotationally drive the nut thereby transmitting a steering force to the steering shaft,
wherein the first connecting passage has a first tapered part at the side farther from the second connecting passage within a circumferential range formed along the other end side opening, the inner diameter of the first tapered part being gradually reduced toward the other end side opening,
the second connecting passage has a second tapered part at the side farther from the first connecting passage within a circumferential range formed along the other end side opening, the inner diameter of the second tapered part being gradually reduced toward the other end side opening, and
the first connecting passage and the second connecting passage are provided to have an angle between the first tapered part and the second tapered part in the rotational direction of the nut, the angle being smaller than 180°.

2. A power steering device as claimed in claim 1, characterized in that the first connecting passage and the second connecting passage are formed by drilling.

3. A power steering device as claimed in claim 2, characterized in that the first connecting passage and the second connecting passage are formed by a drill which moves from the outer peripheral side of the nut toward the inner peripheral side of the nut,
the drill has at its tip end section a tapering section formed tapered along the shape of the first tapered part and the second tapered part, and
the first tapered part and the second tapered part are formed by the tapering section.

4. A power steering device as claimed in claim 1, characterized in that the connecting member has a tube-like shape one end side of which is fittingly inserted into the first connecting passage and the other end side of which is fittingly inserted into the second connecting passage,
the first connecting passage has a first same-diameter part between one end side of the connecting member and the first tapered part, the first same-diameter part serving as a part in which the inner diameter of the first connecting passage is not changed, and
the second connecting passage has a second same-diameter part between the other end side of the connecting member and the second tapered part, the second same-diameter part serving as a part in which the inner diameter of the second connecting passage is not changed.

5. A power steering device as claimed in claim 4, characterized in that the first connecting passage includes a first large-diameter part formed having a diameter larger than that of the first same-diameter part, on one end side of the first connecting passage with respect to the first same-diameter part,
the second connecting passage includes a second large-diameter part formed having a diameter larger than that of the second same-diameter part, on one end side of the second connecting passage with respect to the second same-diameter part, and
the connecting member is attached to be in contact with a first step part at one end side while being in contact with a second step part at the other end side, the first step part being disposed between the first same-diameter part and the first large-diameter part, the second step part being disposed between the second same-diameter part and the second large-diameter part.

6. A power steering device as claimed in claim 1, characterized in that the first tapered part is formed to have a distance between the first tapered part and the outer peripheral surface of the steering shaft-side ball screw groove in the radial direction of the rotation axis of the nut which distance is gradually increased from the side of the ball circulation groove toward the side of the connecting member, and
the second tapered part is formed to have a distance between the second tapered part and the outer peripheral surface of the steering shaft-side ball screw groove in the radial direction of the rotation axis of the nut which distance is gradually increased from the side of the ball circulation groove toward the side of the connecting member.

7. A power steering device as claimed in claim 6, characterized in that the connecting member includes, at one end side, a first guide part opposing to the first tapered part and extending from an opening defined at the other end side of the first connecting passage to the vicinity of the steering shaft-side ball screw groove, and
the connecting member includes, at the other end side, a second guide part opposing to the second tapered part and extending from an opening defined at the other end side of the second connecting passage to the vicinity of the steering shaft-side ball screw groove.

8. A power steering device as claimed in claim 1, characterized in that the first tapered part and the second tapered part have their respective tapered angles of less than 120°.

9. A power steering device as claimed in claim 1, characterized in that the first connecting passage and the second connecting passage are provided to have an angle between the first tapered part and the second tapered part in the rotational direction of the nut, the angle being 90° or more.

10. A method for manufacturing a ball screw for use in a power steering device comprising:
a steering shaft adapted to move in the axial direction together with rotation of a steering wheel thereby steering a steered road wheel;
a nut shaped into a cylinder surrounding the steering shaft to be relatively rotatable with respect to steering shaft;
a ball circulation groove including a steering shaft-side ball screw groove helically formed at the outer periphery of the steering shaft, and a nut-side ball screw groove helically formed at the inner periphery of the nut;
a plurality of balls provided rollably in the ball circulation groove;
a first connecting passage one end side of which is formed to open at the outer peripheral surface of the nut and the other end side of which is formed to open at the inner peripheral surface of the nut and at one end portion of the ball circulation groove;
a second connecting passage one end side of which is formed to open at the outer peripheral surface of the nut and the other end side of which is formed to open at the inner peripheral surface of the nut and at the other end portion of the ball circulation groove;
a connecting member which connects the first connecting passage with the second connecting passage to allow the balls to circulate between the both connecting passages; and
an electric motor able to rotationally drive the nut thereby transmitting a steering force to the steering shaft,
the method being characterized by comprising:
a first step of processing the first connecting passage by a tapered drill the diameter of which is reduced toward its tip end section thereby forming a first tapered part at the other end side of the first connecting passage, the inner diameter of the first tapered part being gradually reduced toward an opening defined at the other end side of the first connecting passage; and
a second step of processing the second connecting passage by a tapered drill the diameter of which is reduced toward its tip end section thereby forming a second tapered part at the other end side of the second connecting passage, the inner diameter of the second tapered part being gradually reduced toward an opening defined at the other end side of the second connecting passage,
wherein the first connecting passage and the second connecting passage are provided to have an angle between the first tapered part and the second tapered part in the rotational direction of the nut, the angle being smaller than 180°.

11. A method for manufacturing a ball screw for use in a power steering device, as claimed in claim 10, characterized in that the connecting member has a tube-like shape one end side of which is fittingly inserted into the first connecting passage and the other end side of which is fittingly inserted into the second connecting passage,
the first connecting passage has a first same-diameter part between one end side of the connecting member and the first tapered part, the first same-diameter part serving as a part in which the inner diameter of the first connecting passage is not changed, and
the second connecting passage has a second same-diameter part between the other end side of the connecting member and the second tapered part, the second same-diameter part serving as a part in which the inner diameter of the second connecting passage is not changed.

12. A method for manufacturing a ball screw for use in a power steering device, as claimed in claim 11, characterized in that each of a pair of the first connecting passage and the first same-diameter part and a pair of the second connecting passage and the second same-diameter part is formed by a single drilling.

13. A method for manufacturing a ball screw for use in a power steering device, as claimed in claim 11, characterized in that each of the pair of the first connecting passage and the first same-diameter part and the pair of the second connecting passage and the second same-diameter part is formed by moving a drill in the same rotation axis.

14. A method for manufacturing a ball screw for use in a power steering device, as claimed in claim 13, characterized in that the first connecting passage includes a first large-diameter part formed having a diameter larger than that of the first same-diameter part, on one end side of the first connecting passage with respect to the first same-diameter part, the second connecting passage includes a second large-diameter part formed having a diameter larger than that of the second same-diameter part, on one end side of the second connecting passage with respect to the second same-diameter part,
each of the first large-diameter part and the second large-diameter part is formed by drilling, and
the connecting member is attached to be in contact with a first step part at one end side while being in contact with a second step part at the other end side, the first step part being disposed between the first same-diameter part and the first large-diameter part, the second step part being disposed between the second same-diameter part and the second large-diameter part.

15. A method for manufacturing a ball screw for use in a power steering device, as claimed in claim 10, characterized in that the first tapered part is formed to have a distance between the first tapered part and the outer peripheral surface of the steering shaft-side ball screw groove in the radial direction of the rotation axis of the nut which distance is gradually increased from the side of the ball circulation groove toward the side of the connecting member, and
the second tapered part is formed to have a distance between the second tapered part and the outer peripheral surface of the steering shaft-side ball screw groove in the radial direction of the rotation axis of the nut which distance is gradually increased from the side of the ball circulation groove toward the side of the connecting member.

16. A method for manufacturing a ball screw for use in a power steering device, as claimed in claim 15, characterized in that the connecting member includes, at one end side, a first guide part opposing to the first tapered part and extending from an opening defined at the other end side of the first connecting passage to the vicinity of the steering shaft-side ball screw groove, and
the connecting member includes, at the other end side, a second guide part opposing to the second tapered part and extending from an opening defined at the other end side of the second connecting passage to the vicinity of the steering shaft-side ball screw groove.

17. A method for manufacturing a ball screw for use in a power steering device, as claimed in claim 10, characterized in that the first tapered part and the second tapered part have their respective tapered angles of less than 120°.

18. A method for manufacturing a ball screw for use in a power steering device, as claimed in claim 10, characterized in that the first connecting passage and the second connecting passage are provided to have an angle between the first tapered part and the second tapered part in the rotational direction of the nut, the angle being 90° or more.
